(19) United States
(12) Patent Application Publication
(10) Pub. No.: US 2012/0315016 A1
(43) Pub. Date: Dec. 13, 2012

(54) Multi-Purpose Image and Video Capturing Device

(76) Inventor: Hei Tao Fung, Fremont, CA (US)

(21) Appl. No.: 13/113,047

(22) Filed: Jun. 12, 2011

(51) Int. Cl. H04N 9/80; H04N 5/228; H04W 88/02

(52) U.S. Cl. 386/248; 455/557; 348/222.1; 348/E05.031; 386/E09.011

(57) ABSTRACT

A multi-purpose image and video capturing device is disclosed. The device comprises a smart phone and a robotic hand gripping the smart phone. The robotic hand is controlled by the smart phone. The smart phone provides the capability of capturing image and video via its camera. Through the application software running on the smart phone, the smart phone can capture image and video in various ways to accomplish different purposes, for example, document image capturing, security camera, video conferencing, etc.

### FIELD OF THE INVENTION

The present invention relates to image and video processing, smart phone applications, and robotics. More specifically the present invention relates to coupling a smart phone and a robotic hand to form a multi-purpose image and video capturing device.

### BACKGROUND

There are plenty of image and video capturing devices, but they tend to be specialized for specific purposes. For example, there are document scanners for capturing document images. There are also security cameras, video conferencing cameras, and personal-use video cameras. Some rely totally on users for their operations. Some exhibit some artificial intelligence, but the artificial intelligence often comes from a server that receives the video and therefore their operations assume the existence of communication link. Robots with computer vision capability can be considered as another form of image and video capturing device, but robots are relatively expensive compared to typical cameras and scanners. The present invention is about an image and video capturing device with artificial intelligence built in that can serve multiple purposes. Nowadays smart phones are becoming ubiquitous and commoditized. Smart phones possess some capabilities such as powerful CPU, camera, microphone, speaker, touch screen for sensing, internet access via wireless connection, etc. The situation presents an opportunity for building a stand-alone multi-purpose image and video capturing device by coupling smart phone and robotic hand and running software application on the smart phone to provide the artificial intelligence. The overall cost of owning such device is made low considering the smart phone being used for many other purposes, the robotic hand being low-cost, and multiple applications being made possible through a variety of application software.

### SUMMARY OF THE INVENTION

A multi-purpose image and video capturing device is disclosed. The device comprises a smart phone, application software running on the smart phone, and a robotic hand that grips the smart phone and is controlled by the smart phone. A smart phone is equipped with powerful CPU, one or more cameras, touch screen, USB, microphone, speaker, Bluetooth, WI-FI, etc. Application software running on the smart phone can provide the artificial intelligence to control when and how to capture the image and video and control the robotic hand to position the smart phone and adjust the vision field of the camera of the smart phone. The device of the present invention can support multiple applications such as home security system, video conferencing system, operator-less video recording, and document imaging as a replacement of document scanner.

### BRIEF DESCRIPTION OF THE DRAWINGS/FIGURES

The present invention will be understood more fully from the detailed description that follows and from the accompanying drawings, which however, should not be taken to limit the disclosed subject matter to the specific embodiments shown, but are for explanation and understanding only.

FIG. 1 illustrates the outlook of an embodiment of the invention disclosed.

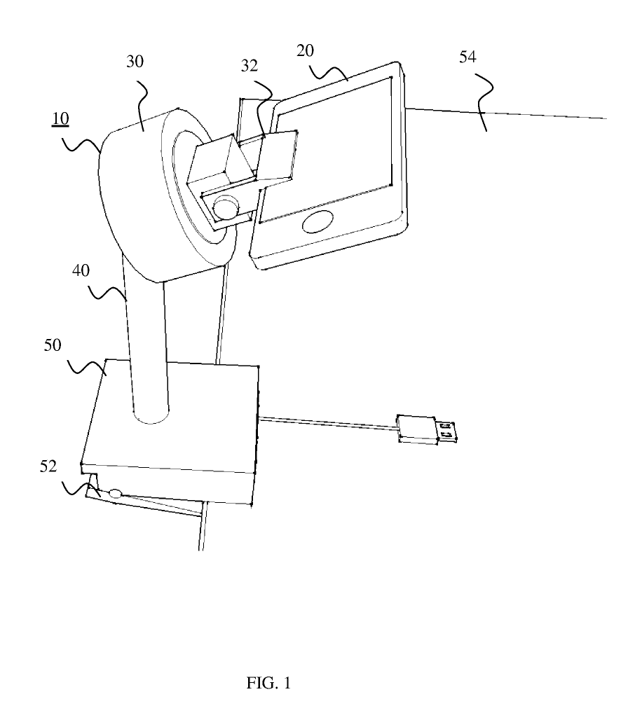

FIG. 2 illustrates the key components of an embodiment of the invention disclosed.

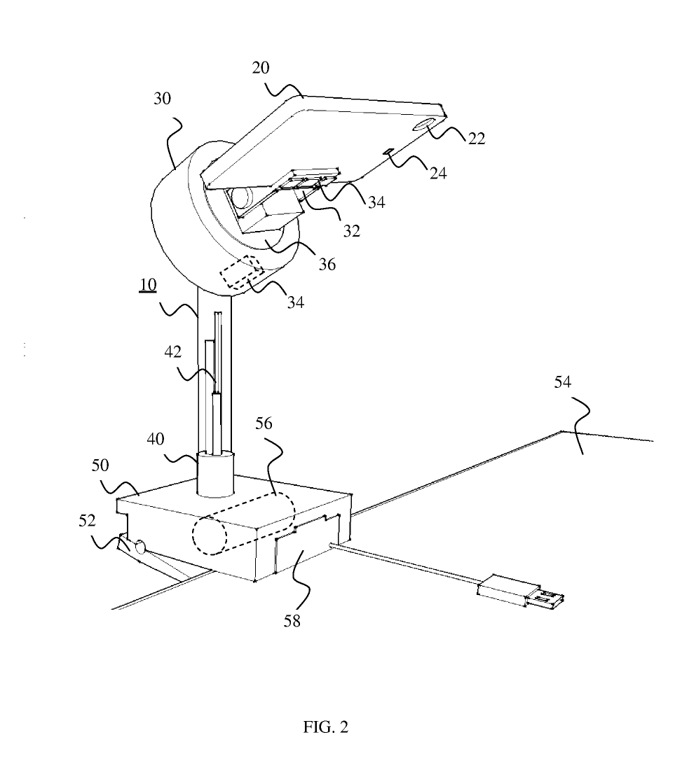

FIG. 3 illustrates an application of an embodiment of the invention disclosed.

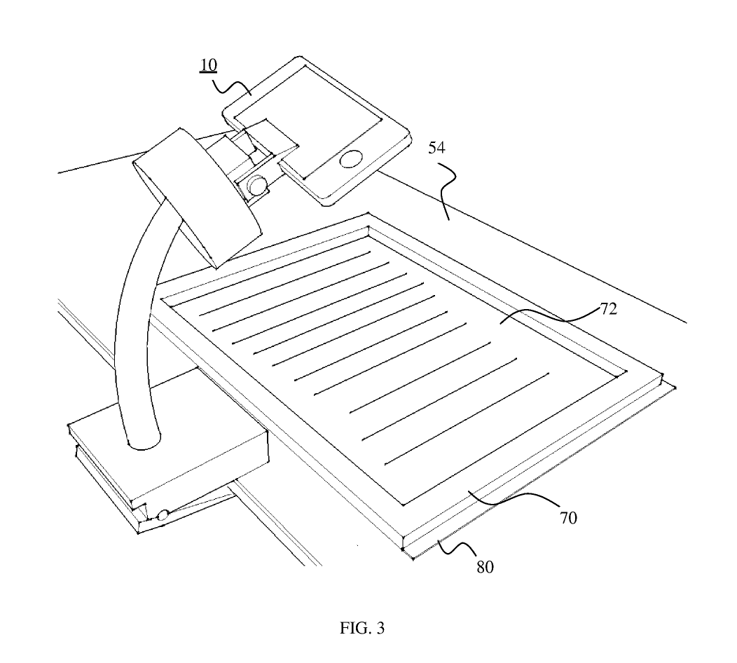

### DETAILED DESCRIPTION OF THE INVENTION

A multi-purpose image and video capturing device 10 comprises a smart phone 20, application software running on the smart phone 20, and a robotic hand 30 that grips the smart phone 20 and is controlled by the smart phone 20.

A smart phone 20 is typically equipped with powerful CPU, one or more cameras, touch screen, USB, microphone, speaker, Bluetooth, WI-FI, etc. With the relevant application software installed, it can be used to capture image and video using its camera 22, exhibit artificial intelligence as to when and how to capture the image and video, and control the robotic hand 30 to position the smart phone 20 for the desirable vision field of the camera 22.

The robotic hand 30 has a gripper 32 that grips the smart phone 20. In our preferred embodiment of the invention, the gripper 32 has two fingers. A user puts the smart phone 20 between the two fingers of the gripper 32. The gripper 32 has springs that provide enough force to firmly grip the smart phone 20 and enough flexibility to accommodate a smart phone of various sizes. Also, the smart phone 20 can be in portrait orientation or landscape orientation between the fingers of the gripper 32. The robotic hand 30 contains electronic means 34 and electromechanical means 36. The electromechanical means 36 of the robotic hand 30 provides two degrees of freedom such that rotation and tilting of the gripper 32 can be achieved. The electromechanical means 36 typically comprises servos. The electronic means 34 of the robotic hand 30 comprises a processing unit that can receive commands from the smart phone 20 via a communication channel and controls the operations of the electromechanical means 36 according to the commands received.

The communication channel can be implemented in a number of ways. It can be a USB connection or Bluetooth connection. It can also be a connection via the phone jack; the electrical signal conveyed through the phone jack connection that is supposed to represent sound can instead be interpreted as commands. In our preferred embodiment, Bluetooth connection is used. The electronic means 34 of the robotic hand 30 therefore comprises a Bluetooth unit.

In our preferred embodiment of the invention, the robotic hand 30 can comprise a DC-powered light 38. The light 38 is attached to the gripper 32 such that it can be a light source in the direction of which the camera 22 is facing.

The robotic hand 30 is supported by an arm 40, and the arm 40 itself is affixed to a base 50. The arm 40 is firm enough to support the weight of the robotic hand 30 and the smart phone 20, but the arm 40 can be adjustable in length and in position relative to the base 50. In our preferred embodiment of the invention, there is a joint between the robotic hand 30 and the arm 40 to provide a 90 degrees freedom such that user can adjust the robotic hand 30 to be upright or sideway relative to the arm 40. The arm 40 is one foot long and is somewhat flexible such that user can slightly bend it so as to adjust the position of the robotic hand 30. There are also electric wires 42 running between the base 50 and the robotic hand 30 through the arm 40. As an example, the arm 40 can be a plastic clad flexible metallic tube with the electric wires 42 embedded inside.

In our preferred embodiment of the invention, the base 50 of the arm 40 comprises a spring clamp 52. Users may clamp the base 50 to a stable object 54. For example, users may clamp the base 50 to the edge of a table, a book, the armrest of a chair, or the back of a chair.

Furthermore, the base 50 contains a power supplying means. The power supplying means supplies the electricity to the robotic hand 30 through the electric wires 42 running through the arm 40. In our preferred embodiment of the invention, the power supplying means comprises a battery charger 58, one or more chargeable batteries 56, and a DC power inlet. Users may use an AC-to-DC adapter to supply electric power to the device 10 through the DC power inlet; when there is no external electricity supplied, the device 10 operates on the batteries 56.

The application software running on the smart phone 20 provides the artificial intelligence to the device 10. It controls when and how the image and video capturing begins, how the image and video capturing continues with respect to the object of interest, processing of the image and video, storage of the image and video, and the transmission of the image and video to a network server.

The image and video capturing can be activated by a combination of sound detection, voice recognition, object recognition, object movement, sudden change of light intensity within the vision field of the camera 22, user inputs inputted on the smart phone 20, user inputs received on the smart phone 20 via communication network, and other means. The activation method used depends on the purpose or the application. For example, using the device 10 as a security camera, the video capturing may be activated by detecting sound, an object moving in the vision field of the camera 22, sudden change of light intensity within the vision field of the camera 22 as in the case where a motion-sensing light being set off, or user inputs. As another example, using the device 10 as a home monitoring system, the video capturing may be activated by detecting a loud sound as in the case of a baby crying, detecting a face that does not match any face stored on an image database, or user inputs via communication network as in the case when a user is checking out her home. As another example, using the device 10 to capture a user playing golf for improving user's golfing skills, the video capturing can be activated by recognition of a spoken word or by recognition of user's face.

To that end, the application software employs a variety of image and video processing techniques, computer vision techniques, and speech recognition techniques.

The detection of object entering the vision field of the camera, object moving within the vision field of the camera, and light intensity change within the vision field of the camera require taking samples of images and comparing images.

The application software can track the object of interest so as to keep the object of interest in the vision field of the camera 22. Applying motion estimation techniques in video processing, when the object's position is close to an edge of the vision field, the application software sends commands to the robotic hand 30 to rotate or tilt towards the direction of the edge so as to center the object of interest in the vision field again. For example, the device 10 tracks the face of the professor who likes to walk around the classroom while the video is being captured.

The application software can also look for an object of interest automatically. For example, in the case that multiple people are involved in a meeting, the people tend to face or look at the person who is talking. By using face detection techniques in computer vision, the direction of the faces is identified, and the robotic hand 30 moves in that direction to look for the person who is talking. Alternatively, if the smart phone 20 supports stereo sound inputs from two microphones, using speech processing techniques and taking advantage of the fact that a single sound source is received at the two microphones at slightly different intensity, the robotic hand 30 can move in the direction where the sound input signal is stronger.

The image and video capturing can be assisted by users. Users may monitor the image and video real-time on the screen of the smart phone 20. Users then may issue user inputs on the smart phone 20. Alternatively, the smart phone 20 transmits the captured image and video to a network server. Users may monitor the image and video using a display device on the network server or a display device on a computer that can access the image and video on the network server. Users then may issue user inputs that are transmitted over the communication network to the smart phone 20.

The application software can apply image and video processing techniques to control and enhance the image and video capturing automatically, and the process can be assisted by other means. For example, the device 10 can be deployed to capture an image of a document 80, as a replacement of a document scanner. Using a camera to capture an image of a document often faces a few problems that affect image quality. Some problems are shaky hands holding the camera, not being able to place the camera exactly on the plane parallel to the document, document not being flattened, uneven or insufficient light intensity on the document, and light source being partially obstructed by user holding the camera. The device 10 in the present invention coupling with the use of a rectangular frame 70 helps solve the aforementioned problems. The rectangular frame 70 can be made of plastic, wood, metal, or other materials. In our embodiment, it is made of plastic, of a non-white solid color, rectangular with straight edges, and of about A4 paper size. The user is to place it on top of the document 80 such that the frame 70 defines the boundaries of the document 80 whose image is to be captured. The weight of the frame 70 helps flatten the document 80 to some degree, but if it is desirable to flatten the document 80 completely, the frame 70 can be made to comprise a transparent, non-reflective plastic plate 72 bounded by the frame 70. The frame 70 is designed to be in a non-white solid color so that image processing techniques can be easily applied. Most documents are on white paper; a non-white solid color helps identify the boundaries of the document 80 through image processing. The device 10 in the present invention can be operated without user holding it. The robotic hand 30 is stable, eliminating the problem of shaky hands. Also, the application software takes advantage of the fact that when the camera 22 of the smart phone 20 is on the plane parallel to the document 80, the image of the non-white solid color frame 70 appears to be rectangular and the edges of the frame 70 in the image are parallel. Applying image processing techniques, the application software controls the robotic hand 30 to position the camera 22 of the smart phone 20 to be on the plane parallel to the document 80. The robotic hand 30 can also provide a light 38 to illuminate the document 80. The advantage is that the light 38 is not obstructed by any part of the device 10. The switching on or off of the light 38 can be controlled by the application software. Once the image of the frame 70 is taken, the application software can crop the image of the document 80 from the image of the frame 70 knowing that the frame 70 defines the boundaries of the document 80. The application software is also capable of capturing the image of a document larger than the frame 70. In that case, the user should place the frame 70 on top of a part of the document and the frame 70 to be partially outside the vision field of the camera 22 when the camera 22 is on the plane parallel to the document. In similar fashion, multiple images can be taken on the parts of the document that form the whole document. The application software combines the images such that the combined image contains the image of the frame 70. Then the application software crops the image of the document from the image of the frame 70.

The present invention can also be implemented using a tablet instead of a smart phone. In that case, the robotic hand, arm, and base are to be scaled in size proportionally.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A multi-purpose image and video capturing device, comprising:
(a) a smart phone that comprises one or more cameras;
(b) application software running on said smart phone; and
(c) a robotic hand that grips said smart phone and is controlled by said smart phone.

2. The device as in claim 1, wherein said robotic hand is affixed to an arm that itself is affixed to a base.

3. The device as in claim 2, wherein said arm is firm but adjustable in position relative to said base.

4. The device as in claim 2, wherein said base comprises a spring clamp that can attach said base to a stable object.

5. The device as in claim 2, wherein said base contains a plurality of batteries.

6. The device as in claim 2, wherein said base contains battery charger.

7. The device as in claim 2, wherein said arm contains electric wires running between said base and said robotic hand.

8. The device as in claim 1, wherein said robotic hand, comprising:
(a) a gripper;
(b) electromechanical means that provides a plurality of degrees of freedom; and
(c) electronic means that receives commands from said smart phone and controls said electromechanical means according to said commands.

9. The device as in claim 8, wherein said gripper is flexible to hold said smart phone that may vary in size and orientation.

10. The device as in claim 1, wherein said robotic hand further comprises a light.

11. The device as in claim 1, wherein said robotic hand provides a plurality of degrees of freedom including rotation of said gripper and tilting of said gripper.

12. The device as in claim 1, wherein said smart phone sends commands to said robotic hand's electronic means via Bluetooth, electrical signals via phone jack, USB, or other communication channels available on said smart phone.

13. The device as in claim 1, wherein said application software captures image and video via said smart phone's camera.

14. The device as in claim 1, wherein said application software can transmit image and video to a network server.

15. The device as in claim 1, wherein said application software can take user inputs inputted on said smart phone or received on said smart phone from communication network.

16. The device as in claim 1, wherein said application software can activate image and video capturing by a combination of sound detection, speech recognition, objection identification, object motion detection, light intensity change in vision field of said camera, and user inputs inputted on said smart phone or received on said smart phone via communication network.

17. The device as in claim 1, wherein said application software can apply intelligent image and video processing techniques on image and video captured.

18. A method of capturing an image of a document, comprising
(a) placing a rectangular frame on top of a document;
(b) capturing one or more images of said rectangular frame using a smart phone; and
(c) applying image processing techniques to crop the image of said document from said image of said rectangular frame based on the boundaries defined by said rectangular frame.

19. The method as in claim 18, wherein said rectangular frame is in a non-white solid color.

20. The method as in claim 18, wherein said rectangular frame may comprise a transparent, non-reflective plastic plate bounded by said rectangular frame.

21. The method as in claim 18, wherein capturing one or more images of said rectangular frame can be automated by running application software on said smart phone to control a robotic hand to grip said smart phone and position said smart phone using said rectangular frame as the reference that defines the boundaries of said document.

22. The method as in claim 18, wherein said one or more images of said rectangular frame can be combined using said rectangular frame as the reference that defines the boundaries of said document by using image processing techniques to form a complete image of said document.

23. The method as in claim 18, wherein said capturing one or more images of said rectangular frame can be enhanced by using a light source.

24. The method as in claim 23, wherein said light source can be controlled by said smart phone.

25. A method of capturing video on an object of interest, comprising
(a) running application software on a smart phone;
(b) using said application software to control a robotic hand that grips said smart phone;
(c) capturing video of object of interest via said smart phone's camera; and
(d) controlling said robotic hand to position said smart phone to keep said object of interest in vision field or look for another object of interest.

26. The method as in claim 25, wherein said object of interest can be the first moving object entering the vision field.

27. The method as in claim 25, wherein said object of interest can be an object matching a specific object stored in an image database.

28. The method as in claim 25, wherein said capturing video of object of interest can be activated by a combination of sound detection, speech recognition, object motion detection, light intensity change in vision field of said smart phone's camera, and user inputs inputted on smart phone or received on smart phone via communication network.

29. The method as in claim 25, wherein said controlling said robotic hand to position smart phone to keep said object of interest in vision field can be automated by applying computer vision techniques to track movement of said object of interest.

30. The method as in claim 25, said controlling said robotic hand to position smart phone to look for another object of interest can be automated by applying face identification and image processing techniques and moving said robotic hand towards the direction of which said face is facing.

31. The method as in claim 25, said controlling said robotic hand to position smart phone to look for another object of interest can be automated by sound processing techniques and moving said robotic hand towards the direction of the microphone that receives a stronger signal than the other microphone.

32. The method as in claim 25, wherein said controlling said robotic hand can be assisted by user inputs inputted on smart phone or received on smart phone via communication network.
